(19) United States
(12) Patent Application Publication
(10) Pub. No.: US 2021/0162971 A1
(43) Pub. Date: Jun. 3, 2021

(54) BRAKE SYSTEM FOR A MOTOR VEHICLE

(71) Applicant: Continental Teves AG & Co. OHG, Frankfurt am Main (DE)

(72) Inventors: Martin Brenn, Frankfurt am Main (DE); Roman Büchler, Frankfurt am Main (DE); Andreas Heise, Frankfurt am Main (DE)

(73) Assignee: Continental Teves AG & Co. OHG, Frankfurt am Main (DE)

(21) Appl. No.: 17/170,278

(22) Filed: Feb. 8, 2021

Related U.S. Application Data
(63) Continuation of application No. PCT/EP2019/070307, filed on Jul. 29, 2019.

(30) Foreign Application Priority Data
Aug. 8, 2018 (DE) 10 2018 213 284.4

(51) Int. Cl. B60T 13/58; B60T 13/74; B60T 8/32; B60T 8/17; B60T 13/68

(52) U.S. Cl. CPC B60T 13/58; B60T 13/741; B60T 13/588; B60T 8/326; B60T 8/17; B60T 13/686; B60T 2270/403; B60T 2270/82; B60T 2270/404; B60T 2240/00; B60T 2220/04; B60T 2270/10; B60T 2270/30; B60T 2270/402

(57) ABSTRACT

A brake system for a motor vehicle, comprises a hydraulic brake arrangement and an electric brake arrangement which are designed to be at least partially redundant with respect to one another. In particular, in the event of failure of hydraulic components, a braking demand can be electrically assisted.

### CROSS-REFERENCE TO RELATED APPLICATIONS

This application claims the benefit of PCT Application PCT/EP2019/070307, filed Jul. 29, 2019, which claims priority to German Application DE 10 2018 213 284.4, filed Aug. 8, 2018. The disclosures of the above applications are incorporated herein by reference.

### TECHNICAL FIELD

The invention relates to a motor vehicle, in particularly, a brake system for a motor vehicle which has a number of wheels.

### BACKGROUND

Motor vehicles are typically equipped with brake systems which act on wheels of the motor vehicle. Typical passenger motor vehicles have, for example, four wheels, all of which can be braked by means of a service brake. In addition, the motor vehicles typically have parking brakes which secure a vehicle against rolling away when at a standstill.

Whereas, in earlier motor vehicles, service brakes and immobilizing brakes were typically considered and implemented separately from one another because they perform different tasks, more recent developments increasingly seek to integrate the two brake systems in order to be able to achieve additional or better functionalities. For this, however, higher demands must also be placed on operational safety.

Therefore, a brake system for a motor vehicle which is designed as an alternative, for example with greater operational reliability is desirable.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The invention relates to a brake system for a motor vehicle which has a number of wheels. The brake system has a hydraulic brake arrangement which is designed to act on a first group of the wheels. The brake system has an electric brake arrangement which is designed to act on a second group of the wheels. The brake system also has a first control arrangement which is configured to control the hydraulic brake arrangement. In addition, the brake system has a second control arrangement which is configured to control the electric brake arrangement. The brake system also has an energy supply arrangement which is configured to supply electrical energy to the first control arrangement and the second control arrangement separately from one another.

Here, the number of wheels corresponds to a plurality. In particular, the number of wheels may corresponds to the number four, such that the motor vehicle has four wheels.

Increased fail-safety can be attained by means of the brake system. This may be because the brake arrangements have separate control arrangements and they can additionally be supplied with electrical energy separately from one another.

The first group of wheels may comprise all of the wheels. This may correspond to a typical design of motor vehicles, wherein all of the wheels are braked.

Typically, the second group comprises only a proportion of the wheels, for example the rear wheels of a motor vehicle. However, the second group may also comprise a different proportion of the wheels, for example also all of the wheels.

A configuration of the energy supply arrangement for the separate supply of energy to the two control arrangements may be implemented for example by means of separate lines or other separate components. In particular, the systems may be of entirely or partially redundant design. This considerably increases the fail-safety.

According to an embodiment, the electric brake arrangement is a parking brake. For example, this may act on the rear wheels of a vehicle. According to another embodiment, the hydraulic brake arrangement is a service brake. For example, this may act on all of the wheels.

For example, a parking brake may be designed to hold a vehicle stationary when at a standstill and to secure said vehicle against unintentional movement. By contrast, a service brake is typically used to decelerate a moving vehicle. However, the functionalities of the different brake arrangements may also be combined.

The hydraulic brake arrangement may have, for the purposes of generating pressure, both a driver-operated brake cylinder and an electrically operated actuator. In this way, two options for generating hydraulic pressure can be combined, wherein both direct operation by a driver and indirect or purely electronically initiated operation by means of an electrically operated actuator are possible. A hydraulic fallback level may be provided in which a driver-operated brake cylinder generates pressure which acts directly on the wheels. This makes it possible to bring a vehicle to a standstill even if all electrical systems have failed.

The energy supply arrangement may have an inverter, a battery and/or a capacitor as a means for drawing and/or storing the electrical energy. This serves to ensure input energy for the energy supply, which can then be transmitted to the control arrangements. An inverter can for example generate alternating current, which can for example be rectified. For example, an alternator may be used for this. A battery can store electrical energy for example for the case of an overload state or a failure of an alternator, and also for a standstill period. A capacitor can be used in particular to bridge short-term fluctuations.

The energy supply arrangement may be designed to selectively connect the first control arrangement and/or the second control arrangement to one or more means for drawing and/or storing the electrical energy. In this way, it can be ensured that energy is supplied to the two control arrangements in the best possible way. Such means may for example be the components mentioned immediately above: inverter, alternator, battery or capacitor.

The first control arrangement may be configured to perform one or more of the following functions: detection and/or processing of a driver braking demand; communication via a CAN bus; communication with a vehicle network; processing of signals from wheel rotational speed sensors; supply of hydraulic energy to the hydraulic brake arrangement; calculation and/or execution of brake control functions, anti-lock brake system (ABS), electric brake force distribution (EBD) and/or electronic stability program (ESP); and ascertainment of a driver demand via a parking brake switch, via a human-machine interface and/or via a vehicle network.

Such functions typically serve for the control of a hydraulic brake system. It should be understood that all possible combinations and sub-combinations of the stated functionalities are possible. A combination with other functions is also possible.

The second control arrangement may be configured to perform one or more of the following functions: detection and/or processing of a driver braking demand; detection and/or processing of standstill information; generation of substitute signals for standstill detection with information from a vehicle network, from a camera, a radar, a transmission and/or a motor; detection and/or processing of wheel slip information; detection and/or processing of a position of an electric parking brake switch; and supply of electrical energy to the electric brake arrangement.

These are typical functionalities of a controller of a parking brake. It should be understood that all possible combinations and sub-combinations of the stated functionalities are possible. A combination with other functions is also possible.

The second control arrangement can be configured to identify a vehicle standstill state, for example by means of wheel rotational speed sensors or camera signals, and to apply a parking brake in response to an activated parking brake switch when a vehicle standstill state has been identified.

According to one embodiment, the first control arrangement and the second control arrangement are configured to boost a driver braking demand by means of the hydraulic brake arrangement if the first control arrangement and the hydraulic brake arrangement are functioning correctly, and to boost a driver braking demand by means of the electric brake arrangement in the event of complete or partial failure of the first control arrangement and/or of the hydraulic brake arrangement.

This, in the case of proper operation of a service brake or of another hydraulic brake arrangement, allows normal braking in response to a driver braking demand, wherein this driver braking demand can be assisted. For example, a pressure generated by a driver in a brake cylinder can be transmitted to wheels, and boosting can additionally be performed by means of a pump, a linear actuator or some other electrically operated device. Alternatively, the driver braking demand may also be detected only electronically, and implemented entirely by electrical pressure generation. A simulator which generates a defined resistance for the driver is typically used for this purpose.

However, if a complete or partial failure of the components required for this occurs, boosting of a driver braking demand can be performed by means of the electric brake arrangement. For example, a pressure generated by a driver in a master brake cylinder can be transmitted to the wheels, wherein the electric brake arrangement generates an additional braking torque. This allows greater safety, because assistance in the implementation of a driver braking demand is implemented even for a complete or partial failure of the hydraulic brake system or of its electrical components.

The embodiment described further above with two separate control arrangements and separate energy supply additionally increases reliability.

The first control arrangement may have one or more of the following components: a power control unit (PCU), which is configured to supply voltage to internal electronics, to read in wheel rotational speed information and/or to control valves and/or a hydraulic actuating means and/or an actuator; and an execution unit for software for the closed-loop control of the hydraulic brake arrangement.

The second control arrangement may have one or more of the following components: a microcontroller which is configured to supply voltage to internal electronics and/or to read in wheel rotational speed information; an execution unit for software for the closed-loop control of the electric brake arrangement; a parking brake control unit which is configured to control an H-bridge; and an H-bridge.

With regard to the abovementioned lists of components, it should be noted that these may be combined with one another in any combination or sub-combination. A combination with other elements is also possible.

Components of the first control arrangement are preferably structurally and/or electrically separate from components of the second control arrangement. This further increases reliability, since, for example, fault states which occur in one control arrangement do not necessarily pass over to the other control arrangement. For example, the effect of overvoltage states can thus be limited. For example, separate circuit boards or housings may be used.

The brake system may be configured to, in the event of a complete or partial failure of the first control arrangement, output a fault message and/or allow operation of the electric brake arrangement, which occurs in response to an identified failure of the first control arrangement, only for a predetermined period of time or until a predefined event. Such a predefined event may for example be a vehicle standstill state or a workshop visit. This counteracts the risk of a driver, even in the event of a complete or partial failure of the hydraulic brake arrangement, relying on the additional action of the electric brake arrangement and postponing or seeking to avoid repair work. For example, by means of the described measures, a driver can be prompted and urged to visit a workshop in order to have the defective components repaired.

The electric brake arrangement may be designed for direct electric braking of the wheels. This may mean that no hydraulic intermediate component is provided. In particular, a component operated by an electric motor, an electromagnet or some other electrical device may act directly to generate the brake force.

The brake system may be designed for a motor vehicle with four wheels, namely with two front wheels and two rear wheels, wherein the first group comprises all four wheels, and wherein the second group comprises the rear wheels. This corresponds to a typical configuration of brake systems in a normal passenger motor vehicle. It should however be mentioned that the brake system can also be used without problems in other vehicles with different numbers of wheels or different division of the first group and the second group.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

Further features and advantages will be gathered by a person skilled in the art from the exemplary embodiment described below with reference to the appended drawing, in which:

FIG. 1 shows a brake system; and

FIG. 2 shows a circuit diagram of components of a brake system.

### DETAILED DESCRIPTION

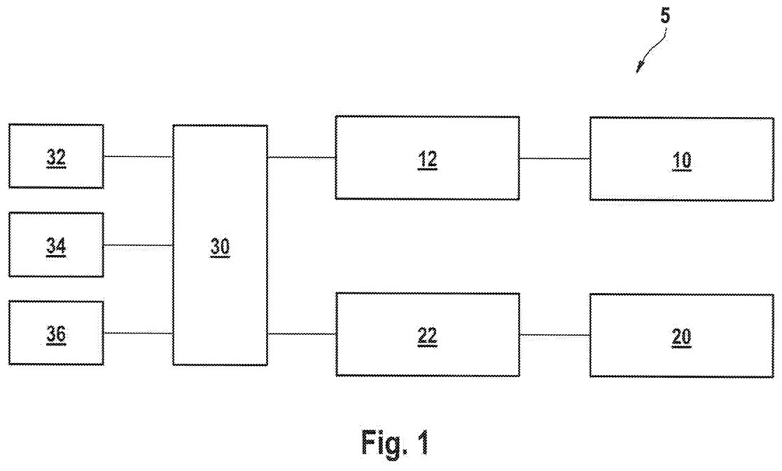

FIG. 1 shows a brake system 5 according to an exemplary embodiment in a purely schematic illustration. The brake system 5 has a hydraulic brake arrangement 10 with an associated first control arrangement 12. The brake system 5 has an electric brake arrangement 20 with an associated second control arrangement 22. The first control arrangement 12 is configured to control the hydraulic brake arrangement 10 and to supply energy thereto. The second control arrangement 22 is configured to control the electric brake arrangement 20 and to supply energy thereto.

An energy supply arrangement 30 is provided for the common energy supply. Said energy supply arrangement has an inverter in the form of an alternator 32, a battery 34 and a capacitor 36.

The energy supply arrangement 30 is designed to selectively connect the first control arrangement 12 and the second control arrangement 22 to each of the components alternator 32, battery 34 and capacitor 36. As a result, electrical energy can be supplied to the two control arrangements 12, 22 and thus also the two brake arrangements 10, 20 separately from one another.

When all components, for example those of the first control arrangement 12 and of the hydraulic brake system 10, are functioning normally, a driver braking demand is detected which can be initiated by the driver for example by operation of a brake pedal. The driver braking demand can then be electrically boosted, for example by means of a linear actuator (not illustrated).

However, if the components required for this fail, then the second control arrangement 22 can use the electric brake system 20 to assist the driver braking demand. Otherwise, the electric brake system 20 serves primarily as a parking brake.

Typical vehicles are presently configured at least such that, in the event of a fault, that is to say in the event of failure of the entire vehicle electrical system, they can perform a deceleration of 2.44 m/s² in the presence of a driver-imparted pressure of 500 N. Typically, however, it is desirable to achieve a deceleration of for example 4 m/s² or 4.88 m/s² in the presence of a brake force of 200 N.

In order to increase the deceleration and/or to reduce the driver-imparted brake pressure required for this, electrical detection and boosting of the driver-imparted brake pressure with the aid of an energy source is typically required.

In normal operation, when the components are functioning normally, a driver braking demand is typically implemented and boosted by means of a hydraulic brake arrangement. In the case of presently used embodiments, however, if this boosting fails, typically only a deceleration of around 2.5 m/s² to 4 m/s² in the presence of 500 N can be ensured.

By means of the embodiment of a brake system described herein, redundancy of the driver boosting can be ensured by establishing independence between the generation of a braking torque by means of a hydraulic actuator and an electric actuator (typically a parking brake). This independence is not only found in the actuator itself, but may for example additionally relate to the following aspects: voltage supply; sensor information (sensor arrangement); evaluation (logic arrangement); and execution (actuator arrangement).

The embodiment of a brake system 5 described herein ensures that a driver braking demand is implemented by means of hydraulic or electrical boosting in the case of a majority of the known individual faults. This boosting may be provided for example at the rear axle.

The components described in FIG. 1 may communicate with one another in particular by means of a vehicle bus, for example a CAN bus. For the sake of simplicity, such a bus system is not illustrated.

The first control arrangement 12 and the hydraulic brake arrangement 10 can also be regarded as a first path of the brake system 5. The second control arrangement 22 and the electric brake arrangement 20 can accordingly be regarded as a second path of the brake system 5. Here, the two paths are preferably of redundant design with respect to one another.

Here, the first path typically has the following tasks: detection of a driver braking demand; establishment of communication with the vehicle network; reading-in of the wheel rotational speed sensor information; supply of hydraulic energy (“brake pressure”) to the brake system; and calculation of the associated brake control functions such as ABS, EBD or ESP (also referred to as AYC).

The second path typically has the following tasks: detection of the driver braking demand; detection of the vehicle status with regard to a standstill; detection of the vehicle status with regard to wheel slip; reading-in of the parking brake switch, and supply of electrical energy to the parking brake actuators for the purposes of generating a braking torque by means thereof.

Here, the first path typically represents the capability of an electronic control unit (ECU) to generate a braking torque by means of the hydraulics. The second path typically represents the capability to generate a braking torque by means of a parking brake actuator.

The boosting of the driver braking demand is implemented by means of in each case one of these paths or else both paths. As long as the first path is available, the boosting is typically performed by means of the hydraulics for reasons of comfort. In the event of failure or unacceptable degradation, this boosting can be performed by the second path. A combination is also possible.

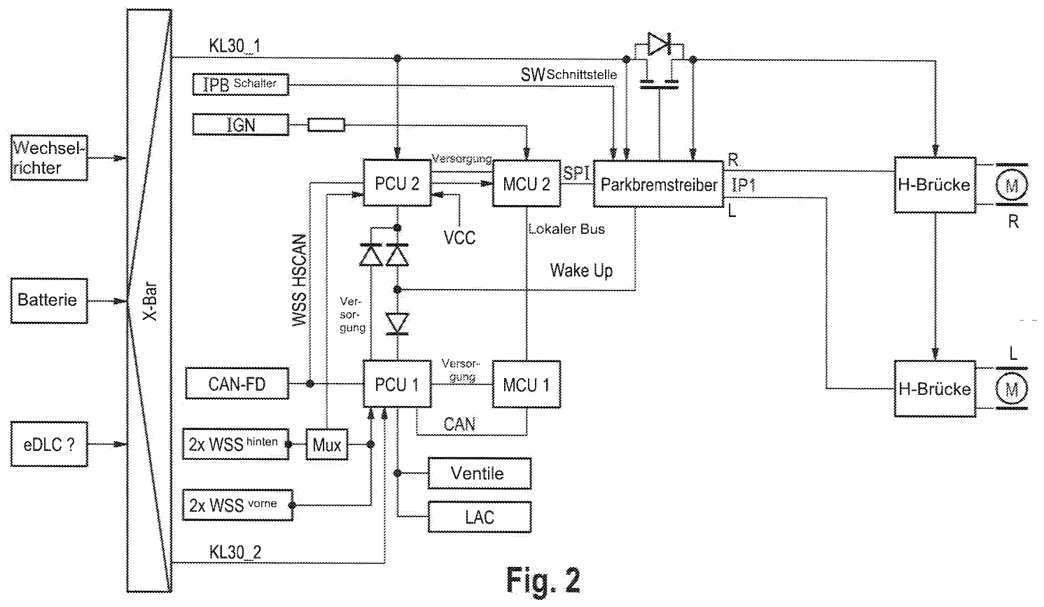

FIG. 2 shows a circuit diagram with one possible redundancy concept with regard to sensors, processing and actuators.

Here, the left side as far as the X-bar serves for generation of mutually redundant voltages KL30_1 and KL30_2.

This may be implemented as follows: safeguarding of the independence between KL30_1 and KL30_2 through clear separation of the input voltages; and switchover capability of the X-bar to switch the input voltage to KL30_1 and/or KL30_2 depending on the state.

In the present case, the execution paths are composed of the following modules:

First path (“hydraulics”):
PCU 1: voltage supply to the internal electronics, reading-in of the wheel rotational speed information, and control of the valves (“valve”) and the hydraulic actuating means (“LAC”); and
MCU 1: execution unit for the software of the hydraulic brake control system (CPU).
   Second path (“parking brake”):
PCU 2: as a voltage supply to the internal electronics, reading-in of the rear wheel rotational speed information;
MCU 2: execution unit for the software of the parking brake control (CPU);
parking brake driver: control of the H-bridge for the operation of the parking brake actuator; and
H-bridge: control of the current on the basis of control commands from the IPEX.

Alternatively, the components in the respective paths may be combined in a different way, as long as the independence of these from the components in the other path is ensured.

Below, a description will be given of a function of the illustrated system, which can for example ensure redundancy:

1. In the absence of faults, the wheel slip in the first path is ascertained directly from the wheel rotational speed information. If this communication path fails, the rear wheel rotational speed signals are switched over to the second path by means of a switchover within the control unit (MUX). By means of this switchover, the second path can independently control the wheel slip.

2. If the source itself fails, driver-boosted operation is possible by means of the first path. The brake force distribution can be set by means of a static EBD with a fixed characteristic curve, such that safe driver boosting is possible without slip occurring prematurely at the rear axle (correct locking sequence).

3. The signals of the wheel rotational speed sensors or the signal of the driver demand are transmitted to the second path via the internal bus, such that the parking brake software located there allows the static release or setting of the parking brake only in the safe state.

4. In the control unit, there are two independent sensors for establishing the driver braking demand (normally a pressure sensor and a position sensor). Normally, both sensors are connected to the first hydraulic path in order to allow a quick reaction to the driver demand. In the event of a fault, one of the sensors is routed to the second path by means of a switchover mechanism. This can be utilized to read in and evaluate the driver demand and to allow closed-loop control of the braking torque by means of the electric parking brake actuator.

5. The system will use monitoring mechanisms to check the functioning of the valves, hydraulic actuating means and the parking brake actuators. If a loss of redundancy has occurred here, the driver must be warned. In addition, the braking demand is boosted by means of the other path.

6. If the driver is already performing a hydraulic braking operation and if a loss of the boost capability is detected by means of existing pressure and/or volume monitoring, the driver is informed and the second path is activated.

7. In order to ensure that the system is woken up by a parking brake switch, the second path is provided with the facility to wake up the first path via a wake-up line.

8. If the capability to identify a standstill state by means of the wheel rotational speed sensors has been lost, both the first path and the second path can establish standstill information from other sensors of the vehicle via CAN communication. This may for example be a camera, a radar or a transmission.

The components and procedures mentioned are merely exemplary. They may be implemented completely as mentioned or else individually or in any combination.

Electric boosting of a braking demand can in particular be set such that the deceleration desired by the driver is achieved. At the start of a braking process initiated by the driver, purely hydraulic braking without boosting typically takes place. Above a certain value, the electric parking brake is controlled in closed-loop fashion such that a defined braking torque is generated and thus the vehicle is additionally decelerated.

After a certain period of time, for example ignition changeover, the electric boosting can be deactivated or reduced. This may be expedient if the boosting by means of the electric parking brake does not lead to such a loss of comfort that the driver or owner of the vehicle initiates a repair because they are also satisfied with the properties of the degraded function. In the case of long-term operation, this would lead to a safety risk and increased wear. The driver should therefore be urged to have the defective components repaired.

It should further be pointed out that refinements, features and variants of the invention which are described in the various embodiments or exemplary embodiments and/or shown in the figures can be combined with one another in any desired manner. Single or multiple features may be interchanged with one another in any desired manner. Combinations of features arising therefrom are intended to be understood to be covered by the disclosure of this application as well.

Features which are disclosed only in the description or features which are disclosed in the description or in a claim only in conjunction with other features may fundamentally be of independent significance essential to the invention. They may therefore also be individually included in claims for the purpose of distinction from the prior art.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1. A brake system for a motor vehicle which has a number of wheels comprising:
a hydraulic brake arrangement which acts on a first group of the wheels;
an electric brake arrangement which acts on a second group of the wheels;
a first control arrangement controllably connected to the hydraulic brake arrangement;
a second control arrangement controllably connected to the electric brake arrangement; and
an energy supply arrangement connected to the to the first control arrangement and the second control arrangement to supply electrical energy to the first control arrangement and the second control arrangement separately from one another.

2. The brake system as claimed in claim 1, wherein the electric brake arrangement is a parking brake.

3. The brake system as claimed in claim 1, wherein the hydraulic brake arrangement is a service brake.

4. The brake system as claimed in claim 1, wherein the hydraulic brake arrangement has a driver-operated brake cylinder and an electrically operated actuator for the purposes of generating pressure.

5. The brake system as claimed in claim 1, wherein the energy supply arrangement has at least one of an inverter, a battery and a capacitor for at least one of drawing and storing the electrical energy.

6. The brake system as claimed in claim 1, wherein the energy supply arrangement selectively connects at least one of the first control arrangement and the second control arrangement to at least one energy supply arrangement for at least one of drawing and storing the electrical energy.

7. The brake system as claimed in claim 1, wherein the first control arrangement is configured for at least one of:
detection and/or processing of a driver braking demand, communication via a CAN bus;
communication with a vehicle network;
processing of signals from wheel rotational speed sensors;
supply of hydraulic energy to the hydraulic brake arrangement;
calculation and/or execution of brake control functions, anti-lock brake system, electronic brake force distribution and/or electronic stability program; and
ascertainment of a driver demand via a parking brake switch, via a human-machine interface and/or via a vehicle network.

8. The brake system as claimed in claim 1, wherein the second control arrangement is configured for one or more of the following functions:
detection and/or processing of a driver braking demand;
detection and/or processing of standstill information;
generation of substitute signals for standstill detection with information from a vehicle network, from a camera, a radar, a transmission and/or a motor;
detection and/or processing of wheel slip information;
detection and/or processing of a position of an electric parking brake switch; and
supply of electrical energy to the electric brake arrangement.

9. The brake system as claimed in claim 1, wherein the first and the second control arrangements are configured to boost a driver braking demand using one of the hydraulic brake arrangement when the first control arrangement and the hydraulic brake arrangement are functioning correctly, and by the electric brake arrangement in the event of at least partial failure of the first control arrangement and/or of the hydraulic brake arrangement.

10. The brake system as claimed in claim 1, wherein the first control arrangement has at least one of the following components:
a power control unit configured to at least one of supply voltage to internal electronics, read in wheel rotational speed information and control valves, and control hydraulic means or an actuator; and
an execution unit for software for the closed-loop control of the hydraulic brake arrangement.

11. The brake system as claimed in claim 1, wherein the second control arrangement has at least one of the following components:
a microcontroller which to supply voltage to internal electronics and/or to read in wheel rotational speed information;
an execution unit for software for the closed-loop control of the electric brake arrangement;
a parking brake control unit which is configured to control an H-bridge; and
an H-bridge.

12. The brake system as claimed in claim 1, wherein components of the first control arrangement are structurally and/or electrically separate from components of the second control arrangement.

13. The brake system as claimed in claim 1, wherein in the event of at least partial failure of the first control arrangement, output a fault message and/or allow operation of the electric brake arrangement, which occurs in response to an identified failure of the first control arrangement, only for a predetermined period of time or until a predefined event.

14. The brake system as claimed in claim 1, wherein the electric brake arrangement is designed for direct electric braking of the wheels.

15. The brake system as claimed in claim 1, wherein the brake system is for a motor vehicle with four wheels, and wherein the first group comprises all four wheels and the second group comprises the rear wheels.
